(19) United States
(12) Patent Application Publication
(10) Pub. No.: US 2017/0098169 A1
(43) Pub. Date: Apr. 6, 2017

(54) PROBABILISTIC MESSAGE DISTRIBUTION

(71) Applicant: LinkedIn Corporation, Mountain View, CA (US)

(72) Inventors: Rupesh Gupta, Sunnyvale, CA (US); Hsiao-Ping Tseng, Fremont, CA (US); Ravi Kiran Holur Vijay, Mountain View, CA (US); Romer E. Rosales, Burlingame, CA (US)

(21) Appl. No.: 14/874,201

(22) Filed: Oct. 2, 2015

(51) Int. Cl. G06N 99/00; G06N 7/00; H04L 12/58

(52) U.S. Cl. CPC G06N 99/005; H04L 51/32; G06N 7/005

(57) ABSTRACT

This disclosure relates to systems and methods that include configuring a machine learning system to train on a plurality of messages, solving, for a set of input messages, a multi-objective optimization problem to minimize a number of messages to send while satisfying one or more constraints, selecting a random value for a message in the set, setting a send constraint for the message in the set using the send threshold for the message in the set and the random value, and sending the message in the set in response to the send constraint being satisfied.

### TECHNICAL FIELD

The subject matter disclosed herein generally relates to managing a social networking service, more particularly, to efficient message distribution to members of the social networking service.

### BACKGROUND

Providers and administrators of an online social networking service distribute messages to members for a variety of different reasons. Conventionally, members of the online social networking service desire communication regarding membership, event notification, connections, advertisements, promotions, or other aspects of a social network.

However, sending messages for every event, connection, update, advertisement, or the like, may overwhelm a messaging system and may annoy members due to messages not being sufficiently relevant to the member or the member's interests. Determining when a specific message is sufficiently relevant or interesting to a given member is difficult.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking service, in an example embodiment.

FIG. 2 is a block diagram illustrating one example scenario that includes a message transmission system according to one example embodiment.

FIG. 3 is another block diagram illustrating an example scenario that includes a message transmission system according to one example embodiment.

FIG. 4 is a schematic block diagram illustrating components of a content filtering system, according to one example embodiment.

FIG. 5 is a schematic block diagram illustrating another example scenario for a message transmission system, according to an example embodiment.

FIG. 6 is a flow chart diagram illustrating a method of efficient message distribution, according to an example embodiment.

FIG. 7 is a flow chart diagram illustrating a method of efficient message distribution, according to an example embodiment.

FIG. 8 is a flow chart diagram illustrating a method of efficient message distribution, according to an example embodiment.

FIG. 9 is a flow chart diagram illustrating a method of efficient message distribution, according to an example embodiment.

FIG. 10 is a block diagram illustrating components of a machine able to read instructions from a machine-readable medium.

### DETAILED DESCRIPTION

The description that follows includes systems, methods, techniques, instruction sequences, and computing machine program products that embody illustrative embodiments of the invention described in the present disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

### Basic Description

Example methods and systems are directed to efficient message distribution. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Techniques for efficient message distribution have been developed that provide for determining outcome probabilities for a given message and determining whether to send the message based on the outcome probabilities. Therefore, a message transmission system may restrict message transmission to those messages that will more likely elicit a response from or be more interesting to members of an online social networking service.

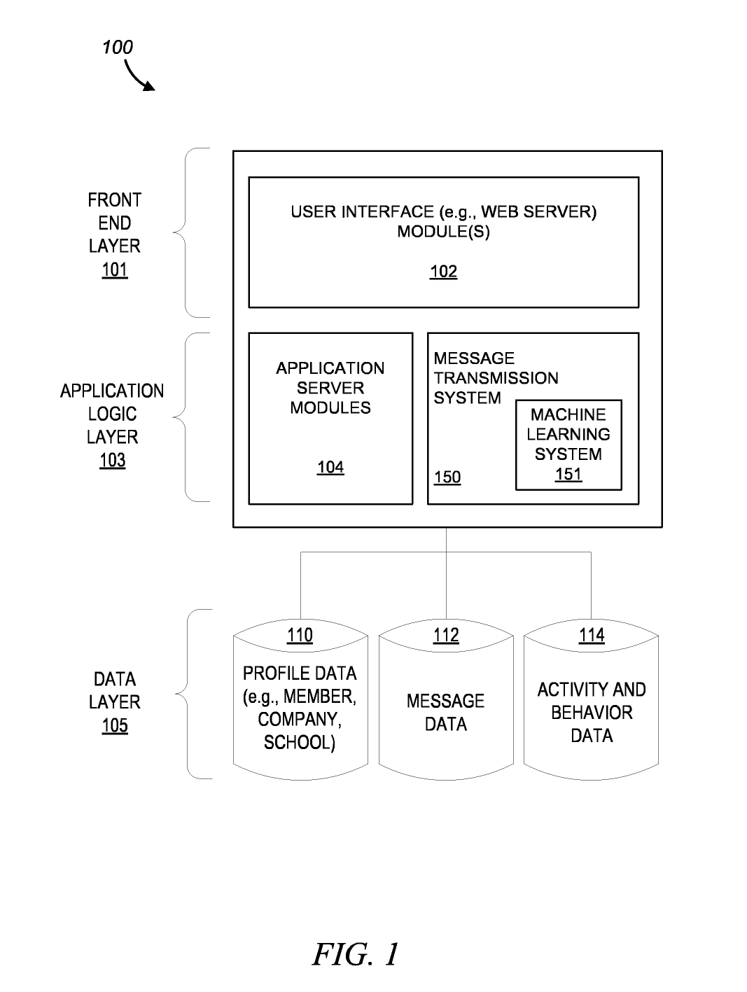

FIG. 1 is a block diagram illustrating various components or functional modules of an online social networking service system 100, in an example embodiment. The online social networking service 100 may be utilized to manage message distribution messages. In one example, the online social networking service 100 includes the message transmission system 150 that performs the various message outcome probability operations described herein. As will be further described, the message transmission system 150 includes a machine learning system 151.

A front end layer 101 consists of a user interface module (e.g., a web server) 102, which receives requests from various client-computing devices and communicates appropriate responses to the requesting client devices. For example, the user interface module(s) 102 may receive requests in the form of Hypertext Transport Protocol (HTTP) requests, or other web-based, application programming interface (API) requests. In another example, the front end layer 101 receives requests from an application executing via a member's mobile computing device. In one example, a member submits media content for inclusion in the online social networking service 100, or requests media content from the online social networking service 100.

An application logic layer 103 includes various application server modules 104, which, in conjunction with the user interface module(s) 102, may generate various user interfaces (e.g., web pages, applications, etc.) with data retrieved from various data sources in a data layer 105.

In some examples, individual application server modules 104 may be used to implement the functionality associated with various services and features of the online social networking service. For instance, the ability of an organization to establish a presence in the social graph of the online social networking service 100, including the ability to establish a customized web page on behalf of an organization, and to publish messages or status updates on behalf of an organization, may be services implemented in independent application server modules 104. Similarly, a variety of other applications or services that are made available to members of the online social networking service may be embodied in their own application server modules 104. Alternatively, various applications may be embodied in a single application server module 104.

In some examples, the online social networking service 100 includes the message transmission system 150, such as may be utilized to transmit messages, track user response to the messages, train a machine learning system 151 to solve a multi-objective optimization problem, and transmit a message in response to a random number satisfying a send constraint for the message. In one example, the message transmission system 150 transmits the message in response to the random number being below a send threshold for the message. In another example, the message transmission system 150 transmits the message in response to the random number exceeding the send threshold. Therefore, in certain embodiments, the send threshold represents a send probability while in other embodiments, the send threshold represents a no-send probability.

As illustrated, the data layer 105 includes, but is not necessarily limited to, several databases 110, 112, 114, such as a database 110 for storing profile data, including both member profile data as well as profile data for various organizations. Consistent with some examples, when a person initially registers to become a member of the online social networking service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the online social networking service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

The online social networking service 100 may provide a broad range of other applications and services that allow members the opportunity to share and receive information, often customized to the interests of the member. For example, with some examples, online social networking service may include a photo sharing application that allows members to upload and share photos with other members. With some examples, members may be able to self-organize into groups, or interest groups, organized around a subject matter or topic of interest.

In another example embodiment, the message transmission system 150 stores messages in the message data database 112. The message transmission system 150 may also store any and/or all message related information in the message data database 112.

As members interact with the various applications, services, and content made available via online social networking service, information concerning content items interacted with, such as by viewing, playing, and the like, may be monitored, and information concerning the interaction may be stored, for example, as indicated in FIG. 1 by the database 114. Thus, previous interactions with a content item by various members of the online social networking service 100 may be stored and utilized in determining, among other factors, how various types of content items, such as organic content items and sponsored content items, result in differences in engagement levels with the content items by members of the online social networking service 100.

In certain examples, member interactions with the online social networking service are based on a link in a message. For example, the online social networking service may include a link (e.g., a universal resource located (URL)). In response to the member clicking on the link, the member then initiates an interaction with the online social networking service. This initial interaction, as well as subsequent interactions in the user session, may also be stored in the database 114 and associated with the message sent. Therefore, message data may also include user interactions with the online social networking service 100 based on a received message.

Although not shown, with some examples, the online social networking service 100 provides an application programming interface (API) module via which third-party applications can access various services and data provided by online social networking service. For example, using an API, a third-party application may provide a user interface and logic that enables the member to submit and/or configure a set of rules used by the message transmission system 150. Such third-party applications may be browser-based applications, or may be operating system-specific. In particular, some third-party applications may reside and execute on one or more mobile devices (e.g., phone, or tablet computing devices) having a mobile operating system.

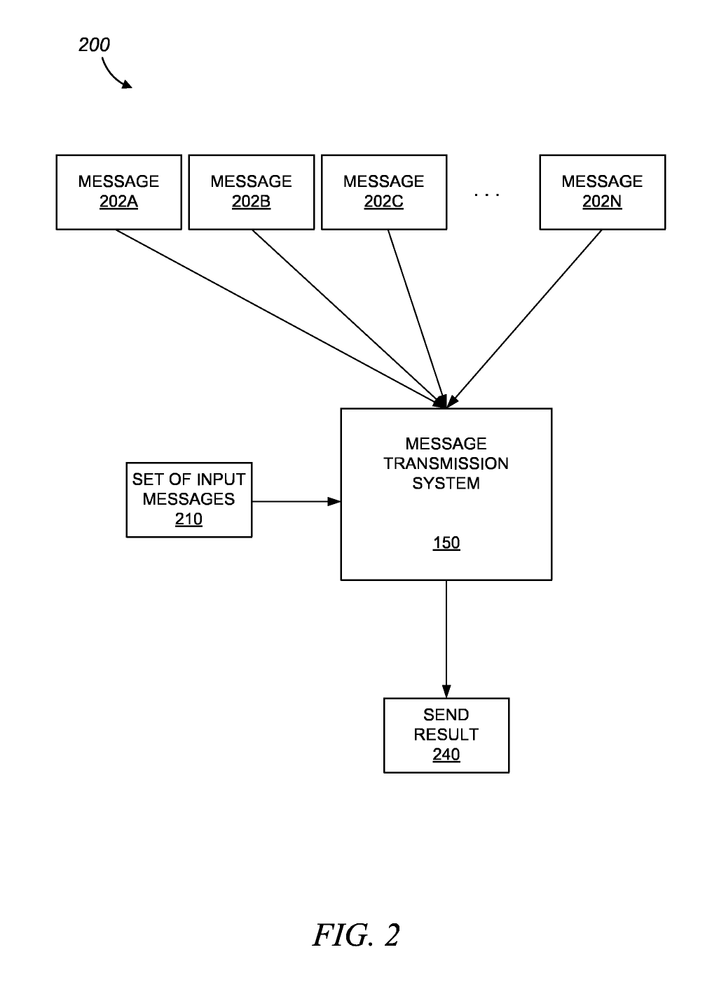

FIG. 2 is a block diagram illustrating one example scenario 200 that includes a message transmission system 150, according to one example embodiment. According to this example, the scenario 200 includes a plurality of messages 202, the message transmission system 150, a set of input message 210, and a send result 240.

In one example embodiment, the online social networking service 100 transmits the messages 202 to various members of the online social networking service 100. For example, the first message 202A includes a text based link for the member to select. In response to the member selecting the link, the message transmission system 150 tracks interactions between the user and the online social networking service 100. In one example, the member selects or views an available item. In another example, the message transmission system 150 tracks interactions between the user and the online social networking service 100 for 15 minutes in response to an initial interaction.

In another example, the second message 202B includes an advertisement. In response to the member selecting to view the advertisement, the message transmission system 150 stores that the member selected the advertisement. Therefore, the database 114 may include a data record that the specific advertisement resulted in a positive interaction with the user (the user selecting the advertisement).

In one example, the third message 202C includes a link; however, the member that received the third message 202C reports that the message 202C is spam. In response, the message transmission system 150 records that the message resulted in a negative response from the member. Of course, other members may not indicate that the message is spam and this disclosure is not limited this regard.

In another example embodiment, a member that receives the fourth message 202N unsubscribes from a mailing list at the online social networking service. In this example embodiment, a negative response includes the member unsubscribing from the mailing list. In response, the message transmission system 150 stores a record in the database 114 indicating that the user unsubscribed in response to the message 202N. Although the letter ‘N’ in the message 202N may indicate a fourth message, this disclosure is not limited in this regard as ‘N’ may indicate any number of messages. In one example, the N^{th} message indicates the 100^{th} message.

In certain embodiments, as many messages are transmitted to members of the online social networking service 100, the message transmission system 150 trains a machine learning system 151 based on the messages 202 and either positive, negative, or no responses from members that received the messages 202. The message transmission system 150 further solves a multi-objective optimization for a current set of input messages 210 to optimize a summation of send probabilities while satisfying one or more constraints. For example, the message transmission system 150 determines send probabilities for each of the messages in the set of input message 210 while keeping an expected number of positive responses above a threshold number, and an expected number of negative responses below a threshold number. In one specific example, the threshold number of positive responses is 1,000,000 and the threshold number of negative responses is 400,000.

In one example embodiment, the message transmission system 150 receives a set of input messages 210. A set of input messages, as described herein, includes at least two or more message that has not yet been sent. One of the messages in the set may include a message received from a member for potential transmission to other members of the online social networking service 100. As will be further described, the message transmission system 150 applies the machine learning system 151 to generate expected numbers of negative and positive responses, applies the expected responses to the set of input messages 210 to determine send probabilities for each message in the set. The message transmission system 150 then generates a random number for each message in the set of input messages 210 and sends the message where the random number for the message satisfying a send constraint for the message.

In one specific example, the send threshold for each message is between 0 and 1, and the message transmission system 150 selects a random value between 0 and 1. In this example, the send constraint is being less than the send threshold. In response to the random value being less than the send threshold for the message, the message transmission system 150 sends the message. Of course, other values and numeric ranges may be used and this disclosure is not limited in this regard.

Accordingly, the message transmission system 150 significantly reduces a number of messages sent to members of the online social networking service 100 but maintains substantially similar positive results. In certain embodiments, results include responses to the messages. The message transmission system 150 also increases the relevancy of messages to members by not sending message that will not likely result in positive responses from members.

In other examples, as many messages that include certain terms result in more positive responses from members, the machine learning system 151 increases an expected number of positive responses for input messages that include those terms. Also, the machine learning system 151 learns times or transmission channels for sending messages that result in more positive responses. For example, historical messages that are transmitted at lAM may result in increased positive feedback versus similar messages that are transmitted at 12 PM. Therefore, the machine learning system 151 also adjusts expected positive and negative responses based, at least in part, on a time when the message is transmitted.

In another example embodiment, the machine learning system 151 also includes a location of a recipient for a message and may statistically track various geographic locations. In this way, the machine learning system 151 adjusts expected responses based, at least in part, on the location of the recipient. For example, messages to people in the United States may result in different responses as compared with other countries. The machine learning system 151 may track responses according to cities, counties, states, provinces, countries, continents, planets, or other spatial regions in either two or three dimensions.

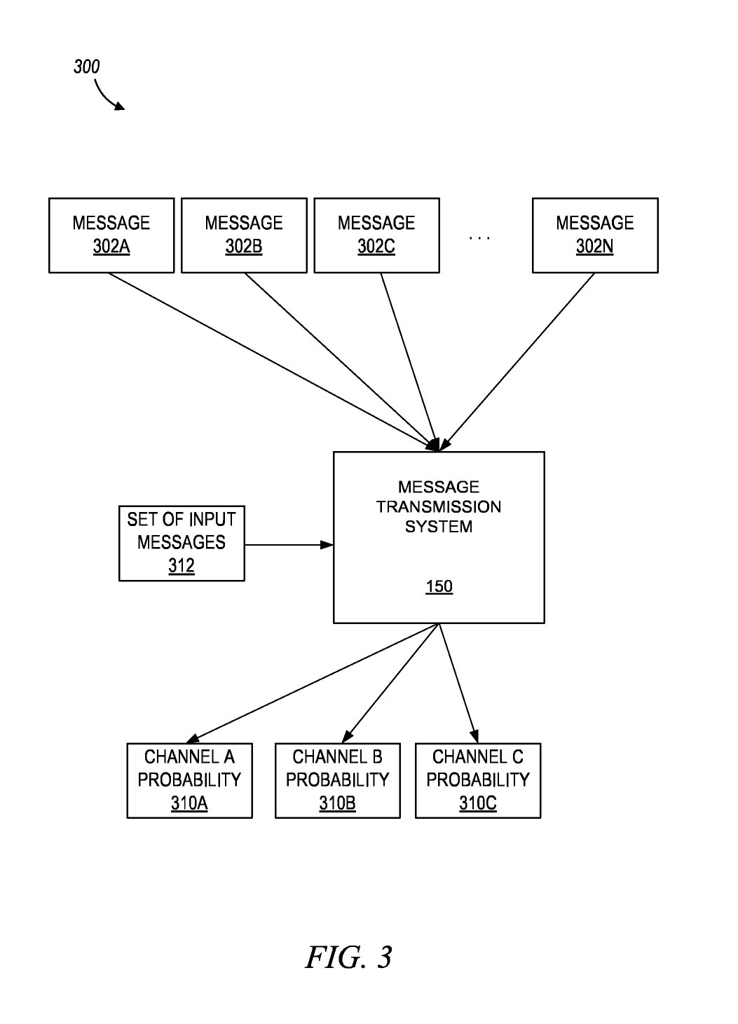

FIG. 3 is another block diagram illustrating an example scenario that includes a message transmission system 150, according to one example embodiment. According to this example, the scenario 300 includes a plurality of messages 302, the message transmission system 150, a set of input messages 312, and one or more channel probabilities 310. The channel probabilities 310 indicate a send threshold for each message in the set of input message 312, whether respective input messages 312 should be transmitted on the channel. In one example embodiment, in response to a random number for a message not satisfying the send threshold for the message, the message is dropped.

In one example embodiment, the online social networking service 100 transmits the messages 302 to various members of the online social networking service 100 using different channels. In one example, the messages 302 are diverse in nature. Of course, they may be the same message sent to different users, but this is a non-limiting example, and the messages 302 may be any message as described herein, or other, or the like.

In one example, the first message 302A is transmitted using a mobile text message (e.g., short messaging service (SMS)) and the user responds positively. For example, the receiver of the text message clicks on an included link to visit a network resource. In this example, the second message 302B is transmitted using email and the receiver responds positively by selecting an advertisement included in the email. In this example, the third message 302C is transmitted using an application notification message and evokes a negative response from the receiver of the third message, and the fourth message 302N is transmitted using a user profile message. The message transmission system 150 trains the machine learning system 151 based on the messages 302, including their respective channels, resulting in a machine learning system 151 capable of generating statistical probabilities whether an input message will cause a negative or a positive response from the receiver of the input message based on the channel used to transmit the message.

In response to receiving the set of input messages 312, the message transmission system 150 combines the expected responses from the machine learning system 151 and output of the multi-objective optimization problem to determine whether to send messages in the set 312. In one example, the solution to the multi-objective optimization problem is send probabilities for each message in the set 312 for each available transmission channel.

In one example embodiment, the message transmission system 150 selects a random number that indicates which channel to use to transmit the message. In one example, for one of the messages in the set 312, the message transmission system 150 generates send probabilities that sum to equal a value of 1. In one example, for an input message in the set 312, the message transmission system 150 determines that the send threshold for channel A is 20%, the send threshold for Channel B is 50% and the send threshold for channel C is 30%. The message transmission system 150 then sets a send constraint that includes each of the channel probabilities 310.

In one example embodiment, the message transmission system 150 selects a random percentage between 0 and 100% and transmits the message via the indicated channel. For example, in response to a random number below 20%, the message transmission system 150 transmits the message via Channel A. In another example, in response to a random number between 20% and 70% (a gap of 50%); the message transmission system 150 transmits the message via channel B. In another example embodiment, the message transmission system 150 configures a biased selector that randomly selects one of the channels according to the channel probabilities for the message. Of course, other values and numerical ranges may be used and this disclosure is not limited in this regard.

In one example embodiment, one of the channels 310 is a dummy channel. A dummy channel at least includes a channel that does not represent a physical transmission medium. A dummy channel, as described herein, includes a virtual representation of a channel that simply drops messages. Therefore, in certain examples, transmitting a message via a dummy channel results in the message being dropped (e.g. not transmitted via any physical transmission medium). In this example embodiment, in response to the random number indicating the dummy channel, the message is dropped. In this way, the mathematical operations used to determine whether the random number indicates a channel or indicates that the message is dropped is simplified because the single random number indicates whether to transmit or drop the message and concurrently indicates which channel to use to transmit the message if it is to be transmitted.

In certain embodiments, a channel is selected from the group consisting of email, mobile text, an application notification, a profile message, and a user interface message. For example, an emailed message includes a message transmitted to an email system for a receiver. In another example, a mobile text message includes an SMS text message transmitted to a receiver's mobile device. In another example, the channel includes a notification from an application executing on a receiver's mobile computing device. For example, the channel may include a notification, an audio sound, a visual graphic, or other, or the like. In another example, the channel includes a profile message. For example, a receiver may authenticate with the online social networking service 100 and may request viewing received messages. In another example, the channel includes a user interface notification. For example, executable code may cause a graphic to be displayed in any way, as one skilled in the art may appreciate. Examples include a pop-up message, a background notification, displayed text, or other, or the like.

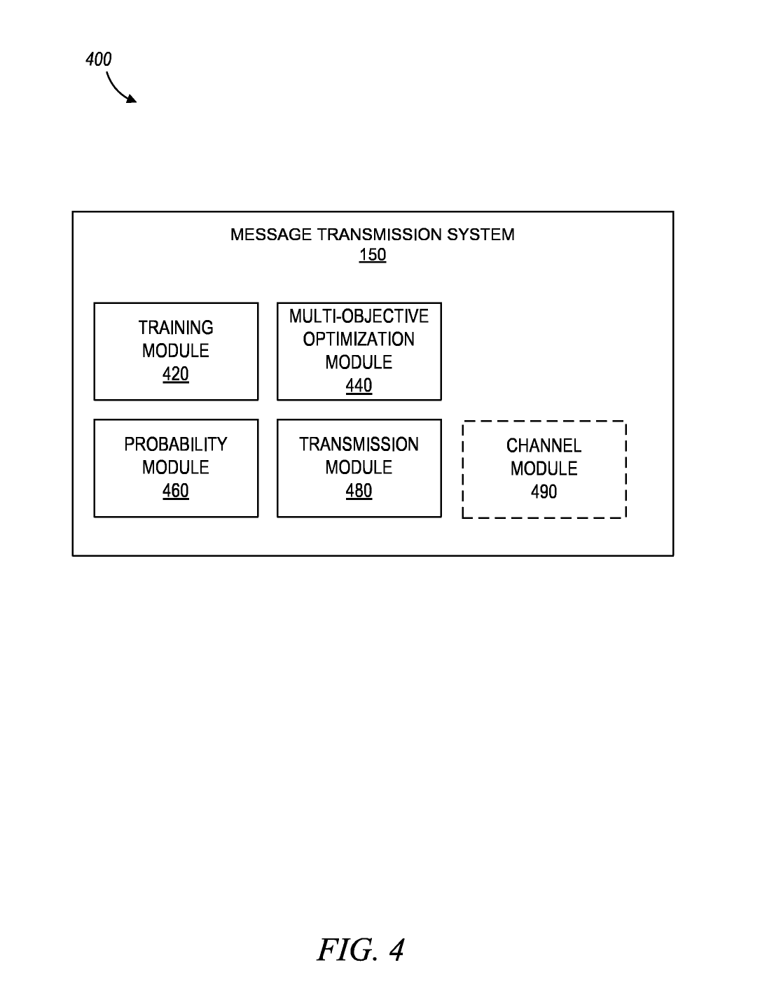

FIG. 4 is a schematic block diagram 400 illustrating components of a message transmission system 150, according to one example embodiment. The message transmission system 150, in one example embodiment, includes a training module 420, a multi-objective optimization (MOO) module 440, a probability module 460, a transmission module 480, and an optional channel module 490.

In one example embodiment, the training module 420 configures a machine learning system 151 to train on a plurality of messages. The training module 420 may train the machine learning system 151 on each and every property of a message. In one embodiment, a list of message properties includes, but is not limited to, a message recipient email, a carbon copy email, a blind carbon copy email, a number of recipients, a subject, a term in the subject, a term in the body of the message, a title, a header, a font size, a font color, a font property, a font type, a length of the message, an attached file, an attached file type, an attached file size, an associated item, an associated event, an included advertisement, a message size, a signature, a priority, a tag, a message type, a maximum line length, a number of terms, a longest term, a language, delayed delivery, a reply message destination, an age of a recipient, a race of a recipient, a gender of a recipient, a response from a recipient, a number of responses from a recipient, a recipient identifying the message as spam, a recipient unsubscribing from a mailing list, a recipient complaining about the message, a recipient purchasing something in response to the message, a recipient visiting a web page in response to the message, a length of a session between a recipient and a network system in response to the message, or any other property, result, or event associated with the message, or the like.

In one example embodiment, the training module 420 trains the machine learning system 151 to output an expected number of positive responses and an expected number of negative responses. The machine learning system 151 may train on properties of the message, properties of a recipient, events associated with the message, or the like. The machine learning system 151 may then operate on an input message (not included in a training set of messages) to generate the expected responses described.

In another example embodiment, the training module trains the machine learning system 151 using user events occurring in response to users receiving the messages 302. In one example, a recipient clicks on a link in a message and visits a web page. The training module includes the page view. Of course, the recipient may also continue interacting with the web page and the training module 420 also trains on these subsequent events. For example, the user may continue selecting pages, entering information, or otherwise interacting with the server providing the web page. In one specific example, the training module trains on events occurring within 15 minutes of the initial page view in response to receiving the message. Of course, other time periods may be used and this disclosure is not limited in this regard. In certain embodiments, the training module 420 associates each event with the message that instigated the events.

In one embodiment, the training module 420 trains using user events based on an Internet Protocol (IP) address for the recipient. Therefore, a recipient may interact with a remote server using different web browsers and the training module 420 still detects the user events.

In another example embodiment, the multi-objective module 440 is configured to solve a multi-objective optimization problem to generate send probabilities for a set of input messages. In one example embodiment, a constraint for the multi-objective optimization problem includes a maximum number of negative responses, a minimum number of positive responses, a ratio of positive responses to negative responses, or other mathematical relationships between expected number of negative responses and an expected number of positive responses.

In another example, the multi-objective module 440 receives threshold percentages from a user of the message transmission system 150. For example, the multi-objective module 440 may receive threshold percentages that indicate a minimum number of messages such that the number of page views remains above 85% of the page views for a previous set of messages and a threshold number of negative responses is 50% of previous negative responses. In one example, the multi-objective optimization problem is configured to minimize the number of messages to send such that the number of page views remains above 85% of the page views for a previous set of messages and a threshold number of negative responses is 50% of previous negative responses.

In another example embodiment, the multi-objective module 440 receives threshold values from a user. For example, the multi-object module 440 may be configured to minimize a summation of send probabilities while maintaining a number of expected positive responses above a threshold number and a number of complaints below a threshold number. In one example, the multi-object module 440 minimizes a number of messages to send while keeping a number of page views above 10,000 and a number of complaints below 1,000. Of course, other values may be used and this disclosure is not limited in this regard.

In certain embodiments, a positive response includes at least one of a page view, a clicked link, a purchase, a like, a comment, a click, a reference, a referral, a vote, or other response that is consistent with a request included in the message, or other response that one skilled in the art recognizes as positive. In other embodiments, a negative response includes at least one of an unsubscribe, a complaint, identifying the message as spam, a dislike, or other response that one skilled in the art would recognize as negative.

In one example embodiment, the training module 420 trains on messages transmitted on a daily basis. In one example, the training module 420 trains on the messages transmitted each day over the past week. In another example, the training module 420 trains on the most recent 100,000 messages. Of course, these values are non-limiting as any number of recent messages may be used to train the machine learning system 151.

In another example embodiment, the multi-objective optimization module 440 solves the multi-objective optimization problem using one or more available linear program solvers to generate a send threshold for each message in the set of input messages as one skilled in the art may appreciate.

In one example embodiment, the probability module 460 is configured to select a random value for respective messages in a set of input messages. Thereafter, for each message in the input set, the transmission module 480 sends the message in response to the random value for the message satisfying a send constraint for the message based on the send threshold for the message.

In one example embodiment, the probability module 460 sets a send constraint that includes the random number being less than a send threshold for the message.

In other example embodiment, the transmission module 480 also determines a time of day to transmit the message. As one skilled in the art may appreciate, transmitting messages at different times affects the receiver's response to the message. Therefore, the training module 420 may train on a time of day when the message is transmitted, the multi-objective optimization module 440 may include a time of day for the multi-objective optimization problem, and the transmission module 480 may transmit the message at the time of day that results in the greatest probability that the message will result in a positive response. In another embodiment, several different times of day are included in the multi-objective optimization problem and the multi-objective optimization module 440 outputs send probabilities for each of the different times of day.

In one example embodiment, probability module 460 linearly assembles the send probabilities for the different times of day. The probability module 460 then generates a random number and the transmission module 480 sends the message at the time of day indicated by the random value.

In one example embodiment, the message transmission system also includes the channel module 490. In one embodiment, the channel module 490 is configured to determine a channel for the message. In one example embodiment, the channel module 490 modifies the multi-objective optimization problem so that the multi-objective optimization problem further outputs send probabilities for each message for the input set and each available transmission channel.

In response, the probability module 460 linearly assembles the send probabilities for the available transmission channels and generates a random value within the range of send probabilities. In one specific example, the range of send probabilities is between 0 and 1, but of course, this is not necessarily the case. The transmission module 480 sends the message via the transmission channel that includes the random value.

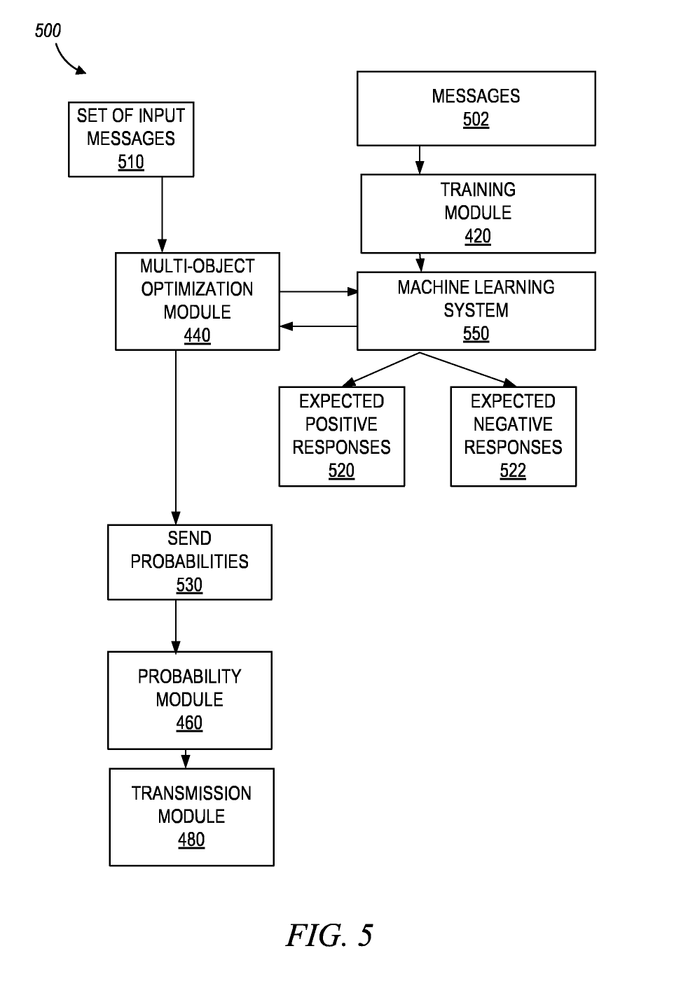

FIG. 5 is a schematic block diagram illustrating another example scenario 500 for a message transmission system, according to an example embodiment. In this example embodiment, the training module 420 trains on a set of messages 502 and is configured to generate an expected number of page views (one example of a positive response) 520 for a set of input messages 510 and an expected number of complaints (one example of a negative response) 522 for the input messages 510.

In this example, the training module 420 trains the machine learning system 550 using previously transmitted messages 502 as described herein. The multi-objective optimization module 440 receives the set of input message 510 and solves a multi-objective optimization problem to generate send probabilities 530 for each of the messages 510.

In one example embodiment, the probability module 460 generates a random value for each message in the set and sets a send constraint for each message in the set using the send threshold and the random value. In response to the random value for each message in the set satisfying the send constraint for respective messages, the transmission module 480 transmits the message.

In certain embodiments, although a multi-objective optimization problem includes the term “optimize,” it is not necessary that the solution be the most optimal solution. In some embodiments, an optimized solution to the multi-objective optimization problem is merely a best solution discovered by the multi-objective optimization module 440. Therefore, the solution may not be “optimal” but may simply be the best so far. The solution may further be dependent on an amount of computing resources applied to the solution. In some examples, the “optimal” solution is a local minimum or maximum. In other examples, the “optimal” solution is without a threshold error from a theoretical optimal solution. In one example, the “optimal” solution is an optimal practical solution which may be less optimal than the optimal theoretical solution. In another example, the “optimal” solution is a point closest to a solution point on a Pareto-optimal front, as one skilled in the art may appreciate.

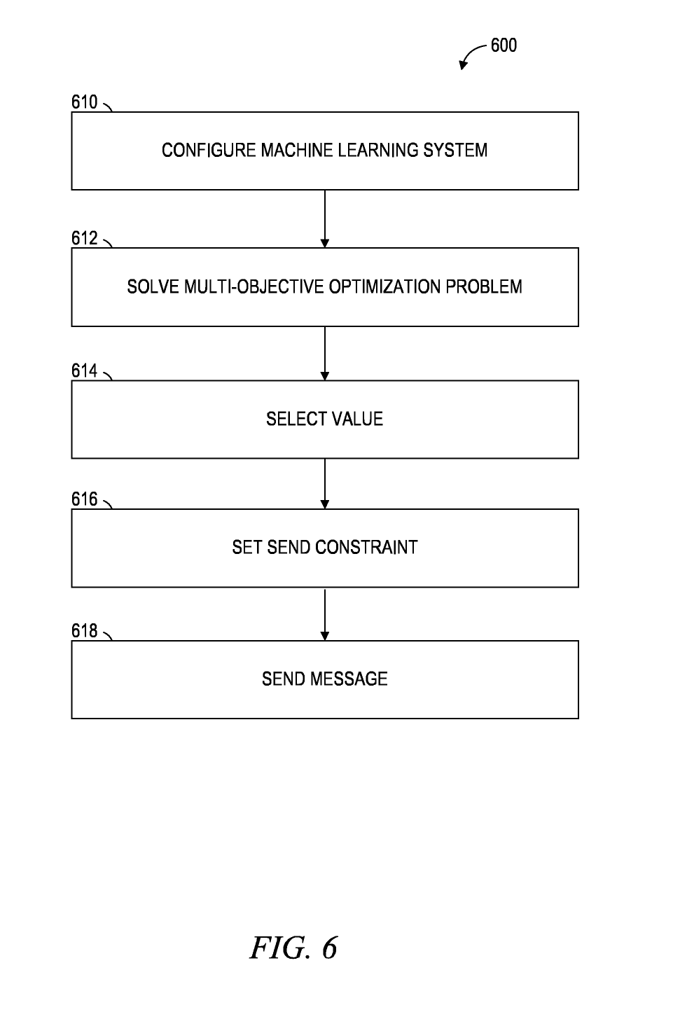

FIG. 6 is a flow chart diagram illustrating a method 600 of efficient message distribution, according to an example embodiment. According to one example embodiment, operations in the method 600 may be performed by the message transmission system 150, using modules described above with respect to FIG. 4. As shown in FIG. 6, the method 600 includes operations 610, 612, 614, and 616.

In one embodiment, the method 600 begins at operation 610 and the training module configures a machine learning system 151 to train on a plurality of messages. In another embodiment, the machine learning system 151 outputs an expected number of positive responses for each message in the set and an expected number of negative responses for each message in the set.

The method 600 continues at operation 612 and the multi-objective optimization module 440 solves a multi-objective optimization problem to generate send probabilities for messages in an input message set.

The method 600 continues at operation 614 and the probability module 460 generates a random value for each of the messages in the input set within the range of the send probabilities. In one example, the send probabilities are between 0 and 1 and the random values are between 0 and 1.

The method 600 continues at operation 616 and the probability module 460 sets a send constraint for each message in the set of messages. In one example, the probability module 460 receives the send constraint from an administrator of the online social networking service. For example, the send constraint may include the random value being less than the send threshold for respective messages in the set.

The method 600 continues at operation 618 and the transmission module 480 sends the input message in response to the random value for the message satisfying the send constraint for the message. In one example, the send threshold is 0.40 and the random value is 0.32. In response to 0.32 satisfying the send constraint of being less than the send threshold of 0.40, the transmission module 480 sends the message. In this example, in response to the random value exceeding the send threshold, the transmission module 480 drops the message.

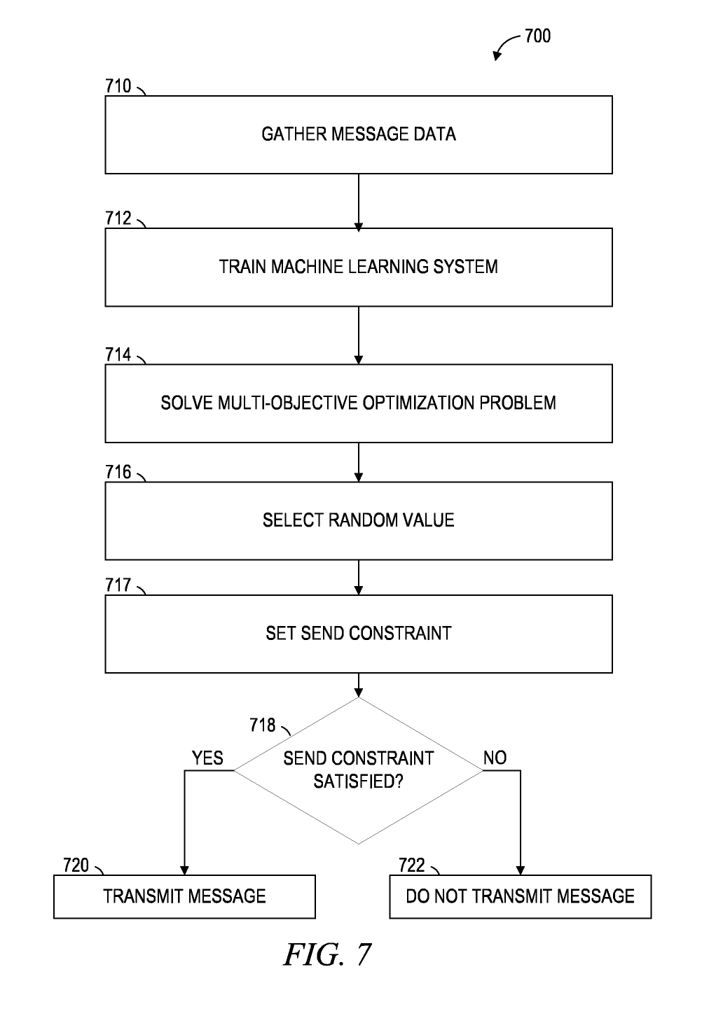

FIG. 7 is a flow chart diagram illustrating a method 700 of efficient message distribution, according to an example embodiment. According to one example embodiment, operations in the method 700 may be performed by the message transmission system 150, using modules described above with respect to FIG. 4. As shown in FIG. 7, the method 700 includes operations 710, 712, 714, 716, 718, 720 and 722.

In one embodiment, the method 700 begins at operation 710 and the training module 420 gathers message data based on a set of messages transmitted to members of an online social networking service. The training module 420, in one example, also gathers responses from the members based on the messages. In one example, a link included in the message also causes a system to notify the training module 420 when the link is clicked, thus notifying the training module 420 when a positive response is received.

The method 700 continues at operation 712 and the training module 420 configures a machine learning system 151 to train on the gathered message data. In another embodiment, the machine learning system 151 outputs an expected number of positive responses for each message in the set of input message and an expected number of negative responses. For example, in response to messages being transmitted to members of an online social networking service, the training module trains the machine learning system 151 on the transmitted messages and responses from the members based on the messages.

The method 700 continues at operation 714 and the multi-objective optimization module 440 solves a multi-objective optimization problem to minimize a summation of send probabilities for the messages in the input set as described herein.

The method 700 continues at operation 716 and the probability module 460 selects a random value for each message in the input set. In one example, the random value is within a numerical range of the send probabilities. In one example, the send probabilities are between 0 and 100, and the random value is between 0 and 100.

The method 700 continues at operation 717 and the probability module 460 sets a send constraint for each message in the set. In one example, the send constraint for a message includes the random value exceeding the value of 1 minus the send threshold for the message.

The method 700 continues at operation 718 and the transmission module 480 determines, for each message in the input set of messages, whether the random value for the message satisfies the send constraint for the message. In response to the random value not satisfying the send constraint, the transmission module 480, at operation 722, does not transmit the message. In response to the random value satisfying the send constraint, the transmission module 480, at operation 720, transmits the message.

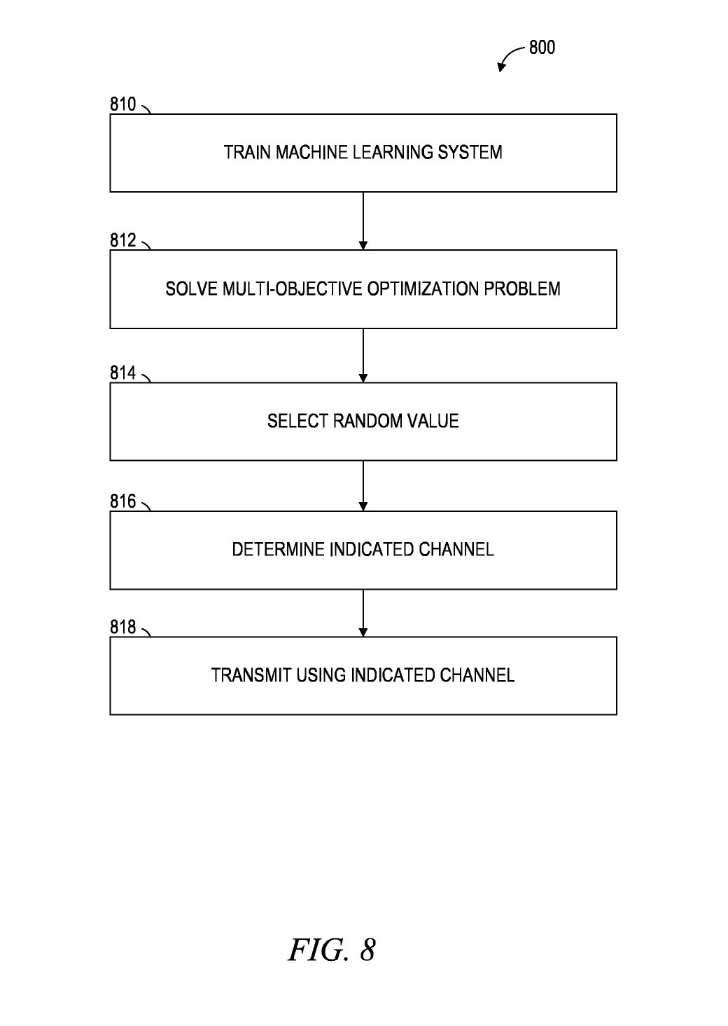

FIG. 8 is a flow chart diagram illustrating a method 800 of efficient message distribution, according to an example embodiment. According to one example embodiment, operations in the method 800 are performed by the message transmission system 150, using modules described above with respect to FIG. 4. As shown in FIG. 8, the method 800 includes operations 810, 812, 814, 816, 818, 820 and 822.

In one embodiment, the method 800 begins at operation 810 and the training module configures a machine learning system 151 to train on a plurality of messages. In one example, thousands or millions of messages are transmitted to members of an online social networking service and the training module trains the machine learning system 151 on the transmitted messages and responses from the members based on the messages.

The method 800 continues at operation 812 and the multi-objective optimization module 440 solves a multi-objective optimization problem to minimize a summation of send probabilities for messages in an input set of messages to generate a send threshold for each message in the input set of messages. In this embodiment, the multi-objective optimization module 440 further considers multiple channels for each message in the set. In one example, the multi-objective optimization module 440 generates send probabilities for each message and for each channel for the message. Therefore, in response to six messages and three channels, the multi-objective optimization module generates 18 send probabilities.

The method 800 continues at operation 814 and the probability module selects a random value for each message. In one example embodiment, the probability module 460 apportions a range between 0 and 1 for each channel based on the send probabilities for the message and channels. In one example, for one message, the channel probabilities are 0.33, 0.37, and 0.30.

The method 800 continues at operation 816 and the channel module 490 determines which channel based on the random value. In one example, in response to the random value being below 0.33, the channel module 490 selects the first channel. In response to the random value being above 0.33, and below 0.7 (0.33+0.37), the channel module 490 selects the second channel. In response to the random value exceeding 0.70, the channel module 490 selects the third channel. In other embodiments, four or more channels are available.

The method 800 continues at operation 818 and the transmission module 480 transmits the message via the selected or indicated channel in response to another random value satisfying a send constraint for the message. For example, in response to the first channel being email and the random value not exceeding the send threshold for the first channel, the transmission module 480 transmits the message via an email message.

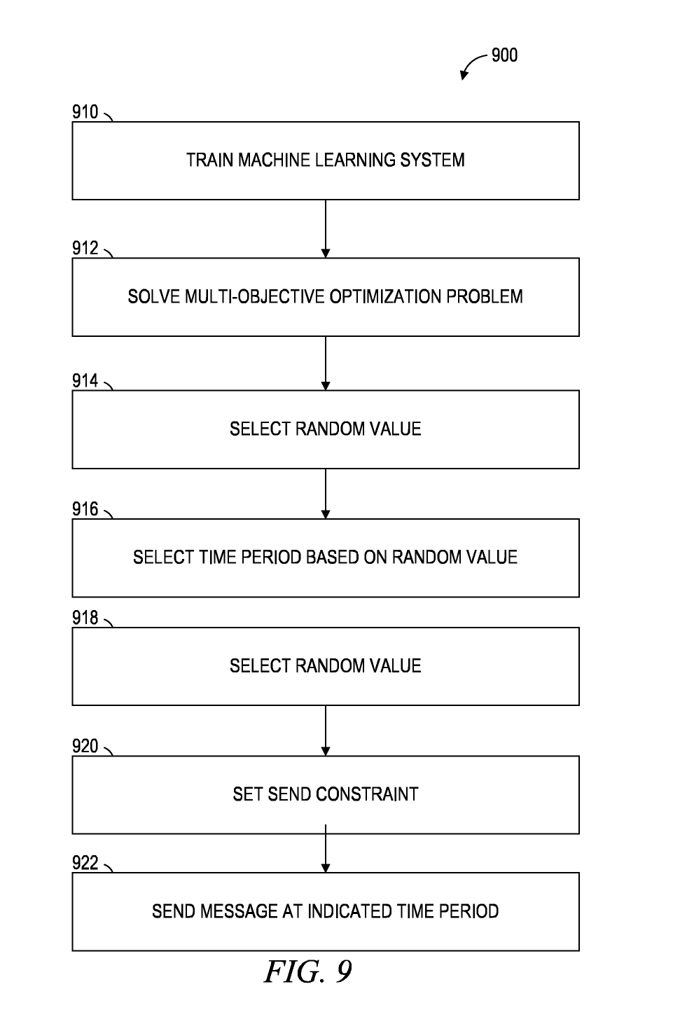

FIG. 9 is a flow chart diagram illustrating a method 900 of efficient message distribution, according to an example embodiment. According to one example embodiment, operations in the method 900 are performed by the message transmission system 150, using modules described above with respect to FIG. 4. As shown in FIG. 9, the method 900 includes operations 910, 912, 914, 916, 918, 920, and 922.

In one embodiment, the method 900 begins at operation 910 and the training module configures a machine learning system 151 to train on a plurality of messages. In another embodiment, the machine learning system 151 outputs an expected number of positive responses for each message in the input set of messages and an expected number of negative responses. For example, thousands or millions of messages are transmitted to members of an online social networking service and the training module trains the machine learning system 151 on the transmitted messages and responses from the members based on the messages.

The method 900 continues at operation 912 and the multi-objective optimization module 440 solves a multi-objective optimization problem to minimize a summation of send probabilities for the set of messages while satisfying one or more constraints. In one embodiment, the constraints include a threshold number of expected positive responses and less than a threshold number of negative responses. In this example embodiment, the training module 440 further includes a time of day when the transmitted messages were sent.

The method 900 continues at operation 914 and the probability module selects a random value for each message in the input set of messages. The method 900 continues at operation 916 and the probability module 460 selects one of the time periods indicated by the random value. In one example, the send probabilities for the different times to send a message are linearly arranged. Based on the random value being within a range of one of the times, the probability module 460 selects the indicated time at operation 916. In certain examples, as one time period results in a much higher send threshold, a corresponding likelihood of random value will be within the numerical range for that time period.

The method 900 continues at operation 918 and the probability module 460 selections another random value. The method 900 continues at operation 920 and the probability module 460 sets a send constraint using the send threshold for the message and the random value. The method 900 continues at operation 922 and the transmission module 480 sends the message at the selected time period in response to the random value satisfying the send constraint.

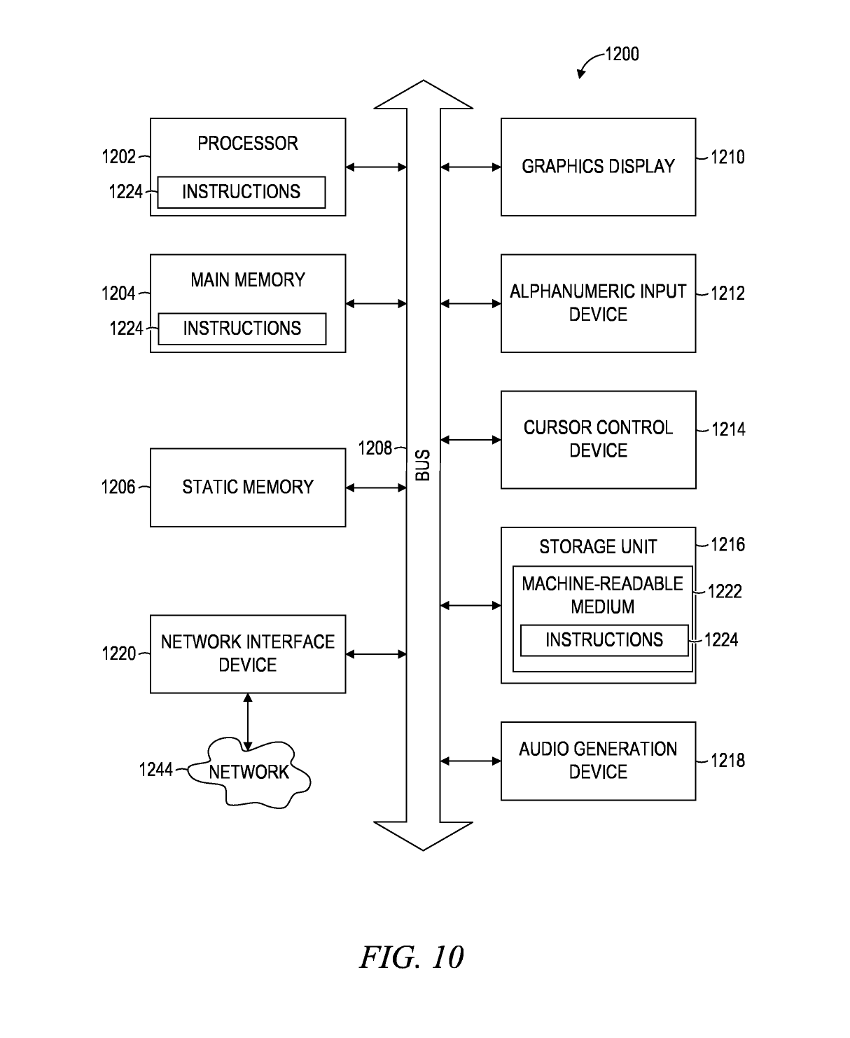

FIG. 10 is a block diagram illustrating components of a machine able to read instructions from a machine-readable medium. Specifically, FIG. 10 shows a diagrammatic representation of the machine 1200 in the example form of a computer system and within which instructions 1224 (e.g., software) for causing the machine 1200 to perform any one or more of the methodologies discussed herein may be executed. In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a peer-to-peer (or distributed) network environment. The machine 1200 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include a collection of machines that individually or jointly execute the instructions 1224 to perform any one or more of the methodologies discussed herein. In certain embodiments, the various modules described in FIG. 4 are implemented as part of the instructions 1224.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The machine 1200 may further include a graphics display 1210 (e.g., a plasma display panel (PDP), a light emitting diode (LED) display, a liquid crystal display (LCD), a projector, or a cathode ray tube (CRT)). The machine 1200 may also include an alphanumeric input device 1212 (e.g., a keyboard), a cursor control device 1214 (e.g., a mouse, a touchpad, a trackball, a joystick, a motion sensor, or other pointing instrument), a storage unit 1216, a signal generation device 1218 (e.g., a speaker), and a network interface device 1220.

The storage unit 1216 includes a machine-readable medium 1222 on which is stored the instructions 1224 (e.g., software) embodying any one or more of the methodologies, modules, or functions described herein. The instructions 1224 may also reside, completely or at least partially, within the main memory 1204, within the processor 1202 (e.g., within the processor's cache memory), or both, during execution thereof by the machine 1200. Accordingly, the main memory 1204 and the processor 1202 may be considered as machine-readable media. The instructions 1224 may be transmitted or received over a network 1244 via the network interface device 1220.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1200), such that the instructions, when executed by one or more processors of the machine (e.g., processor 1202), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
a machine-readable medium having instructions stored thereon, which, when executed by a processor, cause the system to:
configure a machine learning system to train on a plurality of messages, the machine learning system outputting an expected number of positive responses based on an input message and an expected number of negative responses based on the input message;
solve, for a set of input messages, a multi-objective optimization problem to minimize a number of messages to send while satisfying one or more constraints, the multi-objective optimization problem including the expected number of positive responses and the expected number of negative responses for each message in the set, the solving resulting in a send threshold for each message in the set;
select a random value for a message in the set;
set a send constraint for the message in the set using the send threshold for the message in the set and the random value; and
send the message in the set in response to the send constraint being satisfied.

2. The system of claim 1, wherein the one or more constraints includes the summation of send probabilities being below a threshold number.

3. The system of claim 1, wherein the one or more constraints includes the expected number of negative responses being below a threshold number.

4. The system of claim 1, wherein solving the multi-objective optimization problem comprises solving the multi-objective optimization problem for two or more different time periods resulting in send probabilities for each of the message for each of the different time periods, the random value selected to indicate one of the different time periods using the send probabilities for the message.

5. The system of claim 1, wherein solving the multi-objective optimization problem comprises solving the multi-objective optimization problem for two or more different transmission channels resulting in send probabilities for each of the messages and each of the two or more different transmission channel, the random value selected to indicate one of the two or more different transmission channels based on the send constraint, the sending using the indicated transmission channel.

6. The system of claim 1, wherein satisfying the send constraint for a message comprises the random number being lower than the send threshold.

7. The system of claim 1, wherein one or more of the positive responses is selected from the group consisting of a page view, a clicked link, a purchase, a like, and a comment, and one or more of the negative responses is selected from the group consisting of an unsubscribe, a complaint, a dislike, and a spam report.

8. The system of claim 1, wherein the machine learning system is configured to train on a user's activity for a threshold period of time based on a response to one of the plurality of messages.

9. A method comprising:
configuring a machine learning system to train on a plurality of messages, the machine learning system outputting an expected number of positive responses based on an input message and an expected number of negative responses based on the input message;
solving, for a set of input messages, a multi-objective optimization problem to minimize a summation of send probabilities for the messages in the set while satisfying one or more constraints, the multi-objective optimization problem including the expected number of positive responses and the expected number of negative responses for each message in the set, the solving resulting in a send threshold for each message in the set;
selecting a random value for one of the one or more messages in the set;
setting a send constraint for the message in the set using the send threshold and the random value; and
sending messages in the set in response to the send constraint being satisfied.

10. The method of claim 9, wherein the one or more constraints includes the summation of send probabilities being below a threshold number.

11. The method of claim 9, wherein the one or more constraints includes the expected number of negative responses being below a threshold number.

12. The method of claim 9, wherein solving the multi-objective optimization problem comprises solving the multi-objective optimization problem for two or more different time periods resulting in send probabilities for each of the message for each of the different time periods, the random value selected to indicate one of the different time periods using the send probabilities for the message.

13. The method of claim 9, wherein solving the multi-objective optimization problem comprises solving the multi-objective optimization problem for two or more different transmission channels resulting in send probabilities for each of the messages and each of the two or more different transmission channel, the random value selected to indicate one of the two or more different transmission channels based on the send constraint, the sending using the indicated transmission channel.

14. The method of claim 9, wherein satisfying the send constraint for a message comprises the random number being lower than the send threshold.

15. The method of claim 9, wherein one or more of the positive responses is selected from the group consisting of a page view, a clicked link, a purchase, a like, and a comment, and one or more of the negative responses is selected from the group consisting of an unsubscribe, a complaint, a dislike, and a spam report.

16. The method of claim 9, wherein the machine learning system is configured to train on a user's activity for a threshold period of time based on a response to one of the plurality of messages.

17. The method of claim 9, wherein satisfying the send constraint for a message comprises the random number exceeding the value of one minus the send threshold.

18. A non-transitory machine-readable medium having instructions stored thereon, which, when executed by a processor, cause the system to:
configure a machine learning system to train on a plurality of messages, the machine learning system outputting an expected number of positive responses based on an input message and an expected number of negative responses based on the input message;
solve, for a set of input messages, a multi-objective optimization problem to minimize a number of messages to send while satisfying one or more constraints, the multi-objective optimization problem including the expected number of positive responses and the expected number of negative responses for each message in the set, the solving resulting in a send threshold for each message in the set;
select a random value for a message in the set;
set a send constraint for the message in the set using the send threshold for the message in the set and the random value; and
send the message in the set in response to the send constraint being satisfied.

19. The system of claim 18, wherein solving the multi-objective optimization problem comprises solving the multi-objective optimization problem for two or more different time periods resulting in send probabilities for each of the message for each of the different time periods, the random value selected to indicate one of the different time periods using the send probabilities for the message.

20. The system of claim 18, wherein solving the multi-objective optimization problem comprises solving the multi-objective optimization problem for two or more different transmission channels resulting in send probabilities for each of the messages and each of the two or more different transmission channel, the random value selected to indicate one of the two or more different transmission channels based on the send constraint, the sending using the indicated transmission channel.
